(19) United States
(12) Patent Application Publication
(10) Pub. No.: US 2026/0316121 A1
(43) Pub. Date: Oct. 15, 2026

(54) Facility or machine for sorting objects having an improved aeraulic management device

(71) Applicant: PELLENC SELECTIVE TECHNOLOGIES, PERTUIS (FR)

(72) Inventors: David ESTEVE, PEYROLLES EN PROVENCE (FR); Julien CHERADAME, AIX EN PROVENCE (FR); Antoine BOURELY, LA TOUR D'AIGUES (FR)

(21) Appl. No.: 19/485,059

(22) PCT Filed: Apr. 15, 2024
(86) PCT No.: PCT/EP2024/060169

§ 371 Date: Nov. 17, 2025

(30) Foreign Application Priority Data
May 22, 2023 (FR) FR2305002

(51) Int. Cl. B07C 5/36

(52) U.S. Cl. CPC B07C 5/368; B07C 5/362

(57) ABSTRACT

A facility (1) is provided for sorting objects (2) having a sorter (3) of planar geometry with a conveyor (5) transporting the objects (2) to be sorted, an aeraulic management system (4) controlling the circulation of air in the facility (1), a containment structure (9) extending above the conveyor (5) and guiding a laminar air flow (FAL) circulating substantially at the same speed as the objects (2) to be sorted. An outlet box (10) defines sorting compartments (11, 11′) with discharge outlets. The facility has at least one diverting wing (14) arranged and configured to direct at least part, preferably at least half, of the laminar air flow (FAL) leaving the guide tunnel (9′) toward the discharge outlet associated with the compartment (11) for receiving the non-ejected objects (2).

The invention relates to the field of machines or facilities for sorting objects or products, in particular objects or products at least a portion of which is recyclable, the sorting typically taking place in accordance with the material. In this context, the subject of the invention is a facility or machine for sorting objects having an improved aeraulic control device, the sorting being able in particular to be binary or ternary.

More particularly, the invention relates to sorting facilities or machines with planar geometry, preferably of the optical type, equipped with compressed air ejection systems (bar with pneumatic nozzles supplied by solenoid valves) installed at the end of a fast-moving conveyor (speed of 2 to 7 m/s), and controlled in relation to the classification results. One possible type of architecture of such a machine or facility is described, for example, in patent document EP1243350A1 of the applicant.

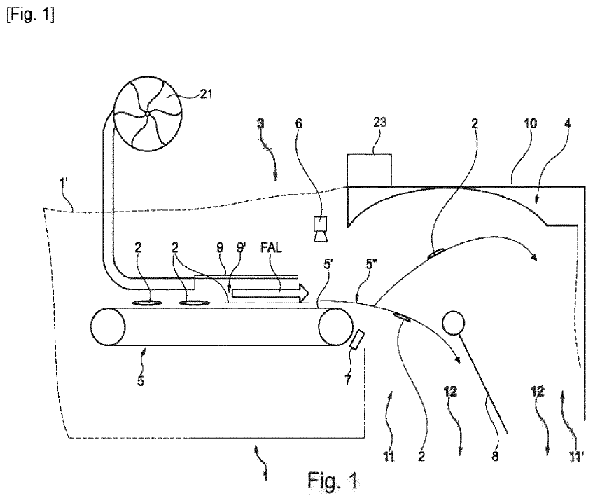

FIG. 1 schematically illustrates a known facility (1) for sorting (here binary sorting) objects (2), comprising, advantageously mounted in a casing (1′), a sorter (3) with planar geometry (sorting objects moving substantially in a monolayer on a plane) and an aeraulic management system (4) controlling the circulation of air in the facility (1).

The sorter (3), preferably of the optical type, comprises at least:
a conveyor (5) with a moving belt (5′) on which the objects (2) to be sorted are arranged in a single layer,
a detection device (6) configured to inspect the objects (2) circulating on the conveyor (5) and classify them after analysis into at least two categories,
an air jet ejection device (7) located at the outlet end (5″) of the conveyor (5) and configured to selectively eject upward the objects (2) detected as belonging to at least one of the classification categories and falling from said outlet end (5″),
at least one separating wall (8) arranged at a distance from the outlet end (5″) of the conveyor (5) and configured to separate from one another a flow of freely falling objects (2) and at least one flow of ejected objects (2).

The aforementioned aeraulic management or control system (4) for its part comprises at least:
a containment structure (9) extending above the conveyor (5) over a longitudinal part of the latter and forming therewith a guide tunnel (9′) into which is injected, by means of an external air injection device (21), a laminar air flow (FAL) circulating substantially at the same speed as the objects (2) to be sorted,
an outlet box (10), forming part of or mounted in the casing (1′) as appropriate, cooperating with the separating wall(s) (8) to constitute a compartment (11) for receiving the non-ejected objects (2) and at least one compartment (11′) for receiving the ejected objects (2), these compartments (11, 11′) having discharge outlets (12) for discharging downward the categorized objects (2) which have fallen or been projected therein.

This facility also comprises a command and control unit (23) for the various aforementioned functional components, in accordance with a dedicated programming and a prior calibration.

Such a sorting facility is marketed by the applicant under the name “Mistral+Connect Full Package” and the containment structure (9), associated with the air injection means and providing the tunnel seat of the laminar flow accompanying the flow of moving objects, is known under the name “Turbosorter” by the applicant. It comprises an optical sorter particularly well suited to sorting light products (plastic films, paper/cardboard), for fractions of 40 to 400 mm.

In this context, the major energy expenditure item for the operator tends to be at the aeraulic and pneumatic levels, namely, by way of illustration:
For the pneumatic aspect: Compressed air from the solenoid valves of the nozzle ejection bars, supplied by industrial compressors with pressures from 6 to 10 bar. Typically, these solenoid valves are operated on or off with an exhaust at atmospheric pressure, and a supersonic velocity at the nozzle outlet, as soon as the (relative) upstream operating pressure exceeds 1 bar;
For the aeraulic aspect: Additional air flow in the circulation of the objects to be sorted to prevent them from sliding on the belt of the rapid sorting conveyor and to accompany their movement to the ejection zone. These air flows are typically created by turbines, with an air velocity of the order of 2 to 7 m/s, and the pressure of these flows is only slightly higher than atmospheric pressure (relative pressure of the order of 0.2 bar).

These two air flows coexist in the object ejection zone, a zone generally delimited by the box, with at least two outlet compartments. Depending on the parameters chosen and the density of the objects to be sorted and ejected, these flows can create turbulence or overpressures detrimental to the proper functioning of the facility.

It has already been proposed to optionally add a system for sucking in air at the outlet of the ejection box in certain applications, in particular in order to discharge the excess air flow created by the additional air flow mentioned above, to avoid overpressures in the box and air cushions at the discharge outlets. It is also an aeraulic system, creating low depressions and velocities of a few m/s.

In addition, the flow of air coming from the tunnel may have difficulty in discharging from the outlet box or from the casing of the machine, an air cushion under overpressure then being created in the outlet box, and the light objects tend to fly above this cushion. Their falling trajectory is then unpredictable, even if they have been ejected, which greatly impairs the quality of the sorting.

Moreover, the presence of sharp edges or angles existing at different points on the trajectory of the air flow leaving the tunnel, in particular around the separating wall, is also a source of turbulence, associated with pressure drops.

It has also been found by the inventors that light and flat objects such as sheets of paper or plastic films have large surface areas which are almost perpendicular to the ejection axis and, as a result, thus greatly disturb the free circulation of air in the compartment(s) of the ejected objects, where they cause overpressures and pressure drops. This harmful effect is substantially proportional to the quantity of objects that occupy this compartment at any time. On the contrary, the surface area of the non-ejected objects (i.e. not subjected to the air jets) is naturally aligned with the direction of their fall parabola under the effect of gravity, which extends beyond the end of the conveyor the plane trajectory they had on the belt of the conveyor forming the sorting belt. This flow of non-blown objects is therefore little disturbed, and shows a high probability of remaining laminar and of not creating overpressure. The overpressure in the compartment(s) for the ejected objects then tends to push the ejected objects back toward the compartment for the non-ejected objects, which degrades the quality of the sorting.

Sorting facilities, corresponding substantially to the aforementioned type, are already known in which an aeraulic control system with a closed (loop) air circuit is present, the air being recirculated between the ejection box and the sorting belt by a turbine. However, these known systems have a complex structure, are very energy consuming (high pressure drop) and are not very adaptable, the air suction and the air injection being linked to one another. A solution implementing mutually independent injection and suction means (for the purpose of expulsion to the outside), which is therefore more flexible and less energy consuming, has already been proposed by the applicant and is described in French patent application No. 2210677 of Oct. 17, 2022.

The main object of the present invention is to overcome, at least in part, the main drawbacks of the known facilities, in particular of the known facility mentioned in relation to FIG. 1 and stated above, by improving in particular the management of the air in such a facility, and more particularly the aeraulics in the outlet box, advantageously passively, without consumption of energy, and possibly being adapted to the intended application for the facility, at least at the time of its assembly/calibration on site, or possibly as a function of a possible evolution of the aeraulic circumstances during its operation.

Preferably, the invention aims to respond to the following two recurring demands:
limiting the energy consumption, and therefore the operating cost of the facility, in particular by optimizing the active consumptions/treatments of pneumatic and aeraulic air,
optimizing the sorting performance by minimizing the disturbances preventing the objects from exiting through the correct discharge outlet.

This object is achieved by the invention, for a facility described above, by the fact that this facility is characterized in that it comprises at least one diverting wing arranged and configured to direct at least part, preferably at least half, of the laminar air flow leaving the guide tunnel toward the discharge outlet associated with the compartment for receiving the non-ejected objects.

The invention will be understood better from the following description, which relates to preferred embodiments that are given by way of non-limiting examples and explained with reference to the appended schematic drawings, in which:

FIG. 1 is a schematic representation of the existing binary sorting facility, known to the applicant and mentioned above;

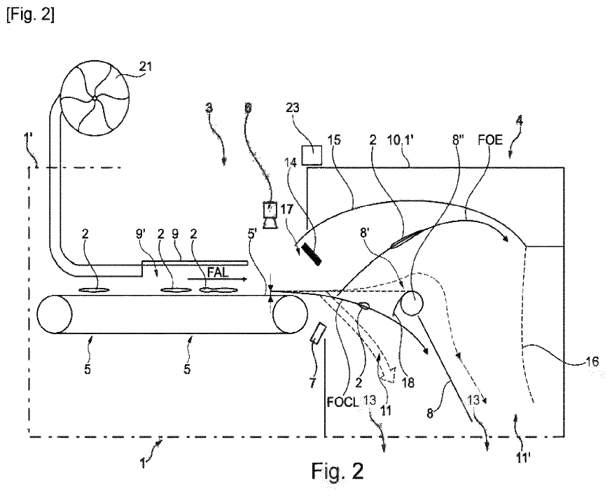

FIG. 2 is a schematic representation of an improved sorting facility according to a first embodiment of the invention of a binary sorting facility;

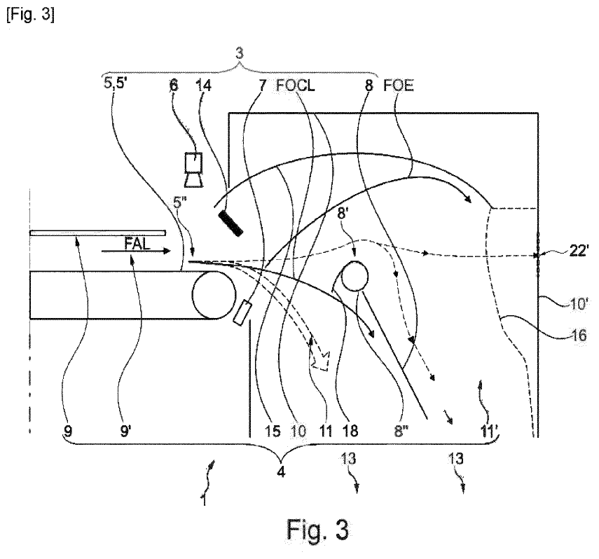

FIG. 3,

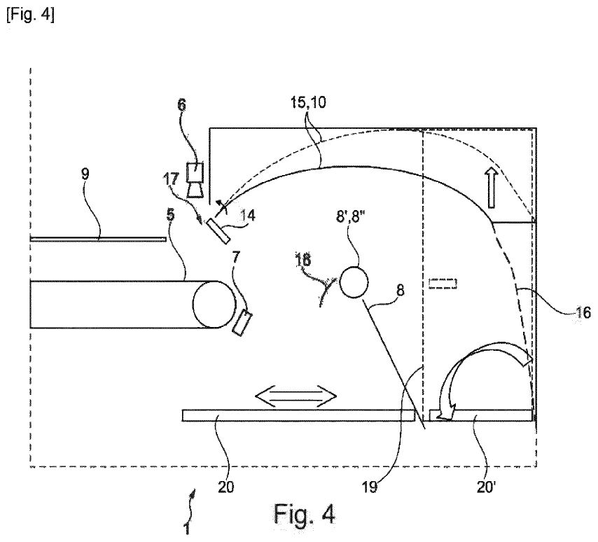

FIG. 4,

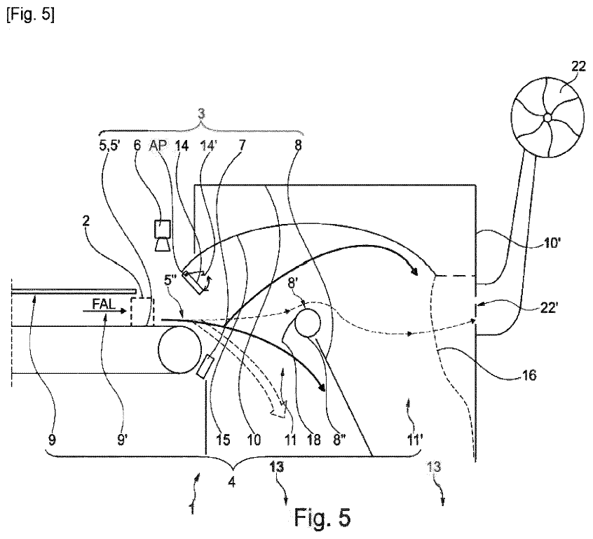

FIG. 5 and

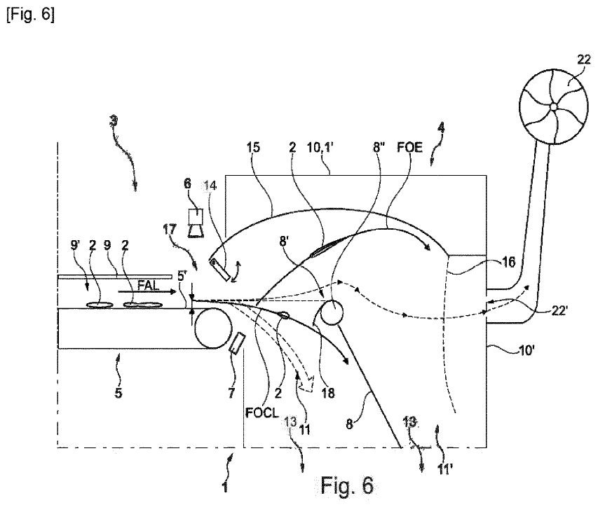

FIG. 6 are partial schematic representations of improved binary sorting facilities in accordance with other embodiments of the invention (in FIGS. 2, 3, 5 and 6, the dashed arrows indicate the circulation of a majority component resulting from the laminar air flow coming from the tunnel above the conveyor and the dashed curved lines punctuated with solid arrows indicate the circulation of a minority component of this flow-the air discharge flows through the discharge outlets are not specifically represented);

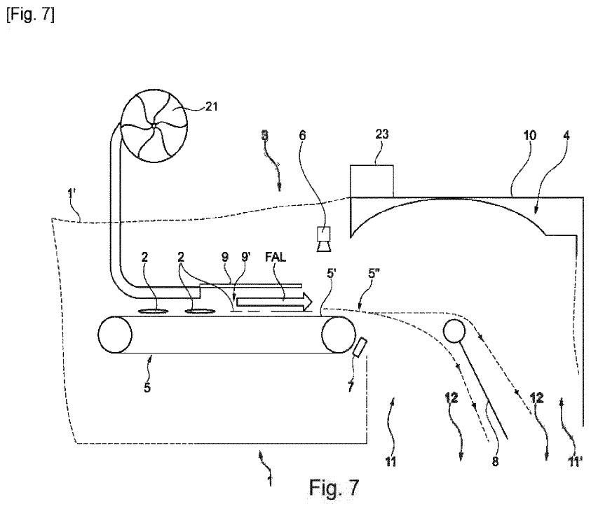

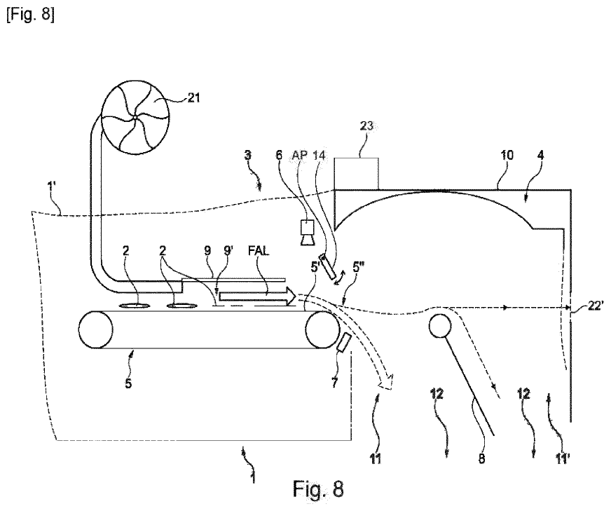

FIG. 7 and FIG. 8 illustrate by comparison with one another the action of the diverting wing on the laminar air flow and the circulation and discharge of air in the outlet box of a facility according to the invention (FIG. 7 illustrates the circulation, partition and outlet of the laminar air flow in a facility according to the prior art, also illustrated by FIG. 1, and FIG. 8 illustrates the circulation, partition and outlet of the laminar air flow in a similar facility but in accordance with the invention);

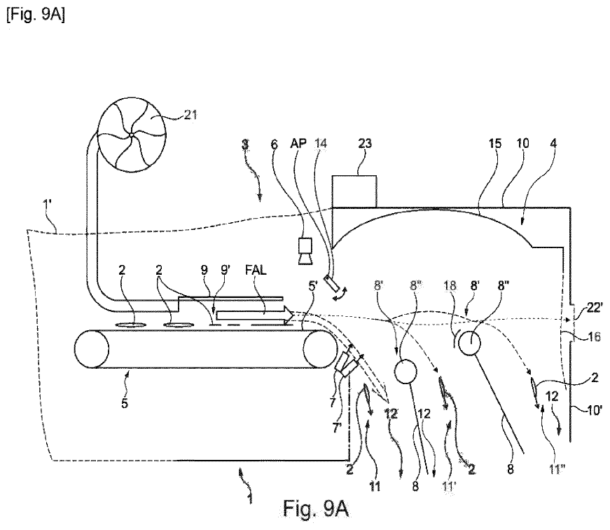

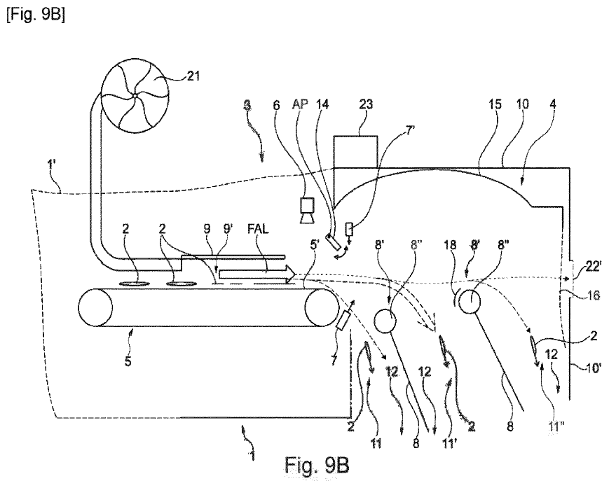

FIG. 9A and FIG. 9B are schematic representations of an improved sorting facility according to two variants of an embodiment of a ternary sorting facility in accordance with the invention, using two bars (the directions of expulsion of the air jets from the two bars are indicated by arrows).

FIG. 2 and partially FIGS. 3 to 6, 8 and 9 illustrate a facility (1) for sorting objects (2), comprising, advantageously mounted in a casing (1′), a sorter (3) with planar geometry and an aeraulic management system (4) controlling the circulation of air in the facility (1).

The sorter (3) comprises at least:
a conveyor (5) with a moving belt (5′) on which the objects (2) to be sorted are arranged in a single layer or monolayer,
a detection device (6) configured to inspect the objects (2) circulating on the conveyor (5) and classify them after analysis into at least two categories,
an air jet ejection device (7), for example in the form of a nozzle bar, located at the outlet end (5″) of the conveyor (5) and configured to selectively eject upward the objects (2) detected as belonging to at least one of the classification categories and falling from said outlet end (5″), and
at least one separating wall (8) arranged at a distance from the outlet end (5″) of the conveyor (5) and configured to separate from one another a flow (FOCL) of objects (2) falling freely (under the effect of gravity at the outlet of the conveyor), on the one hand, and at least one flow (FOE) of ejected objects (2) (ejected under the action of the device 7), on the other hand.

The device (7) may comprise a single bar in which all the nozzles have the same orientation (binary sorting), or it may comprise a bar with at least two types of nozzles alternating and oriented by type in different specific directions, or even at least two parallel bars with each of its nozzles oriented in a suitable manner (ternary or more than ternary sorting).

The aeraulic management system (4) for its part comprises at least:
a containment structure (9) extending above the conveyor (5) over a longitudinal part of the latter and forming therewith a guide tunnel (9′) into which is injected, by means of an external air injection device (21), a laminar air flow (FAL) circulating substantially at the same speed as the objects (2) to be sorted, and
an outlet box (10), forming part of or mounted in the casing (1′) as appropriate, cooperating with the separating wall(s) (8) to constitute a compartment (11 or 11′) for receiving the non-ejected objects (2) and at least one compartment (11′, 11″; 11, 11″) for receiving the ejected objects (2), these compartments (11, 11′, 11″) having respective discharge outlets (12) for discharging downward the categorized objects (2) which have fallen or been projected therein.

According to the invention, the facility (1) comprises at least one diverting wing (14) arranged and configured to direct at least part, preferably at least half, of the laminar air flow (FAL) leaving the guide tunnel (9′) toward the discharge outlet (12) associated with the compartment (11, 11′) for receiving the non-ejected objects (2).

By virtue of these provisions, the invention achieves the main objective set and makes it possible in particular to reduce, or even eliminate, in the presence of an injected laminar air flow, the possible negative impacts which may result from overpressures and/or turbulence, for example on the sorting performance (better reliability and repeatability of the results), while limiting the energy expenditures for the aeraulics to those necessary for injection only, by proposing a passive solution (absence of active or forced air suction for its ejection to the outside).

Preferably, the outlet box (10) is also provided, at least in the lower and/or rear part, and in particular at the discharge outlets (12) and/or the rear wall (1′) of said box (10) located opposite the outlet (5″) of the conveyor (5), with one or more openings (13, 22′) for discharging air at atmospheric pressure, sufficient to substantially limit or avoid overpressure in said box (10) and the formation of air cushions in the discharge outlets (12). For satisfactory operation of the facility over the duration, the configuration, the dimensioning and the arrangement of these openings, in particular that or those (13) at the first discharge outlet (12) and possibly that or those (22′) in the rear part of the box, should be designed so that these openings are not obstructed or slightly obstructed during operation by the sorted objects leaving through said discharge outlets. If necessary, disengagement means, advantageously with automatic operation, may be provided for this purpose (scraper, blower, etc.).

Specifically, by diverting the major part of the air flow (FAL) leaving the guide tunnel (9′) toward the first discharge outlet (12) in the direction of the flow, which obviously has one or more openings (13) toward the outside of sufficient and unobstructed cross section, the invention makes it possible to simultaneously i) suppress the propagation of this flow further into the outlet box (10) where it is likely to create turbulence (e.g. by rebound on walls), ii) avoid the formation of an overpressure in the box, and suppress the cushion effects which may result therefrom, and iii) limit or avoid jams at the separating wall(s) (8), by limiting the quantity of objects landing on its upper edge (8′), while not disturbing the positive action of said flow (FAL) at the conveyor.

The invention also makes it possible to dispense with the need to implement forced air suction, in particular by recirculation with injection, or the presence of a particular air outlet in the upper part of the box (10), which are present in solutions known from the prior art.

With the invention, it is in particular possible to guarantee an optimized aeraulic environment for sorting for variable running speeds, for example 3 m/s, 4.5 m/s or 6 m/s.

The diverting wing (14), which is shown only schematically in the figures, is defined more precisely below by way of a favorable, non-limiting construction.

According to a structurally optimized embodiment, it may be provided that the diverting wing (14) is located after the outlet of the tunnel (9′) for guiding the laminar air flow (FAL), preferably in the extension of and at a distance from the upper wall of the containment structure (9) in the direction of the laminar air flow (FAL), and extends transversely to this direction, so as to be impacted by an upper fraction of said flow (FAL), after it has been ejected from said tunnel (9′). Thus, it influences the direction of propagation of said laminar flow in the box by bending it downward, but without forming an obstacle capable of blocking its propagation.

Advantageously, the diverting wing (14) is arranged between the outlet end (5″) of the conveyor (5) and a front edge of the upper deflecting wall (15), at a distance from the outlet of the guide tunnel (9′). Thus, the inspection window of the detection device (6) is not affected by the presence of this wing.

Preferably, the diverting wing (14) is mounted substantially at the inlet of the outlet box (10) and has a configuration, a dimensioning and an arrangement (in particular position and inclination) such that the upper fraction of the laminar air flow (FAL) which impacts it represents between about 15% and 35%, preferably between 20% and 30%, by volume of said air flow (FAL), and that the portion of said air flow (FAL) diverted toward the discharge outlet (12) associated with the compartment (11) for receiving the non-ejected objects (2), or first discharge outlet, flows substantially along the separating wall (8). This downward flow direction of this diverted fraction, obtained after passage of the flap (18), can in particular be achieved by a suitable inclination of the wing (14).

Thus, by positioning the diverting wing (14) in such a way that it interferes only with a limited upper zone of the extension of the passage of the tunnel (9′), it acts only on an upper fraction of the air flow (FAL) leaving the guide tunnel (9′), which is sufficient to divert it effectively at least in part, preferably at least by half, in the first compartment/discharge outlet, but without, however, constituting an obstacle disturbing said flow, or even a cause of creating turbulence (disturbance of the laminar flow).

Preferably, the diverting wing (14) is configured and positioned in such a way that substantially a majority portion of the laminar air flow (FAL) leaving the tunnel (9′) is positively directed toward the first discharge outlet (12), associated with the negative outlet (without ejection) and adjoining the outlet of the conveyor (5). As a result, the air cushion effects will be suppressed at the other outlet(s) and the ejected object flow(s) (FOE) is/are no longer disturbed, and follow(s) a solely ballistic trajectory.

As shown in FIGS. 5 and 8 and according to a favorable structural feature, making it possible to avoid a possible malfunction due to a blockage of an object (2) of great height at the diverting wing (14), the latter can be mounted with the possibility of being retracted upward, preferably by positive lifting, under the action of an object (2) moving and coming into contact therewith as it passes below said wing (14).

In accordance with a preferred variant, illustrated schematically in FIGS. 5 and 8, the diverting wing (14) is mounted pivotably about an axis (AP) arranged in a plane parallel to the conveying plane and arranged perpendicularly to the direction of travel of the objects (2), said axis (AP) being located at a distance from the plane of the conveyor (5) at least equal to the height of the tunnel (9′) and advantageously extending along one of the longitudinal edges of the diverting wing (14).

This wing (14) can thus pivot between a lower position in which it fulfills its function of diverting at least a portion of the laminar flow toward the first discharge outlet, and a more or less raised position according to the size of the object (2) of great height which lifts it while passing below it. The permitted lifting is at least sufficient for the wing (14) to be able to be arranged entirely in the plane parallel to the plane of the conveyor and comprising the axis (AP). Stops are advantageously provided to define the end pivoting positions, respectively a lower position (current functional position in the absence of the presence of an interfering object) and an upper position (only one upper stop 14′ is shown in FIG. 5). The return to the lower position of the wing (14) can result from the action of gravity alone, or possibly be the result of the combined action of gravity and of a, for example elastic, return means.

In accordance with a possible feature of the invention, the wing (14) may, depending on the intended sorting applications, be adjusted on site in a vertical position and angularly in order to adjust and precisely direct the laminar flow in the box (10) and thus control its effects and adapt it to the different configurations and variants of the facility (type of object to be sorted, binary sorting, ternary sorting). Said wing (14) is preferably rectangular in shape (elongate strip) and flat and extends transversely over the entire width of the conveying belt (5′).

The configuration and arrangement of this wing (14)—length, width, profile/shape, inclination about the axis (AP), positioning in height—are advantageously adapted to the type and size of the facility (1), to the application on site and to the desired aeraulic effects, optionally being at least partially adjustable. They may also be determined so as to create a depression effect in the or each discharge outlet for the ejected objects.

In accordance with an advantageous feature of the invention, which is also beneficial for the aeraulics at the zone for ejecting and physically sorting the objects, and as shown in FIGS. 2 to 6, the facility (1) comprises an upper deflecting wall (15) of concave curved shape, mounted in the outlet box (10) and extending above the openings of the compartments (11, 11′), substantially from the outlet end (5″) of the conveyor (5) and following the containment structure (9), up to a rear wall (10′) of the outlet box (10) or of the compartment (11′) receiving the ejected objects (2), an inspection window (17) for the detection device (6) being arranged between the outlet of said containment structure (9), on the one hand, and said upper deflecting wall (15) and said diverting wing (14), on the other hand (with an unobstructed view on the belt 5′ of the conveyor 5).

It will be noted, by comparing FIGS. 2 to 6 with FIG. 1, that the upper deflecting wall (15), which forms the roof of the box, is lowered further, which allows better control of the trajectory of the ejected objects (2), and the resulting reduction in the internal volume of the box also limits the possibility of turbulence formation.

The combination of the aforementioned wall (15) and wing (14) makes it possible to reduce the turbulent dispersion of the air flow leaving the tunnel at the window (17) and in the outlet box (10) and to guide the majority component of this flow toward the discharge outlet closest to the outlet of the conveyor and the minority component toward the more remote discharge outlet(s). It may of course be envisioned to be able to move this wall (15) and/or this wing (14), in rotation and/or in translation, in order to modify their position and/or inclination, and thus to be able to modify in a controllable manner the circulations of the air flows in the box, and, for example, adapt the aeraulic configurations prevailing in the latter to the types of products to be sorted, to the remaining turbulence and/or to the circumstances in which air is discharged to the outside.

This feature of extending and lowering the deflecting wall (15) is easily identifiable in the accompanying drawings by comparing FIGS. 2 to 6 with FIG. 1. The aforementioned double effect (better guidance and less turbulent dispersion of the air flow coming from the tunnel) can be further increased by extending the or each separating wall (8) upward in such a way that its upper edge is located above the conveying plane (plane on which the moving objects rest), for example from 5 to 15 cm.

As shown in FIGS. 2 to 6 (in particular by comparison with FIG. 1), the facility (1) may advantageously comprise, in the outlet box (10), a strip curtain (16) extending along and, at least in the upper part, at a distance from a rear wall of the outlet box (10) or of the compartment (11′) receiving the ejected objects (2), opposite the corresponding separating wall (8), so as to be located above and partially in the corresponding compartment (11′) for receiving the ejected objects (2), and thus to interfere with the trajectory of the majority of the ejected objects (2), the strips (16) being either freely hanging or secured at their lower ends to the rear wall of the outlet box (10) or of the compartment (11′) receiving the ejected objects (2). These strips (16) can be fastened in the upper part to said upper deflecting wall (15).

By advancing the strips (16) and bringing them closer to the separating wall (8), they are moved into the trajectory of a greater number of ejected objects (2)- and not only of those projected up to the rear wall of the box. Thus, the vast majority of them strike these strips and have their horizontal speed canceled and their trajectory interrupted. Due to their flexibility, the strips (16) stop the horizontal movement by absorbing their kinetic energy. Due to this soft absorption, the objects (2), after coming into contact with these strips (16), slide downwardly along them and do not tend to return rearward. Thus, ejection into the correct discharge outlet (12) is better ensured.

According to two possible structural variants, the strips (16) can either be freely hanging (FIGS. 2 and 6) or be secured at their lower ends to the rear wall (10′) of the outlet box (10) or of the compartment (11′) receiving the ejected objects (2) (FIGS. 3 to 5). These strips (16), which are or are not secured at their lower ends to the rear wall of the outlet box (10) or of the compartment (11′) receiving the ejected objects (2), and which are fastened as appropriate in the upper part to the deflecting wall (15), are spaced apart from one another and constitute a curtain apertured by passages in the form of slots. These strips (16) also prevent ejected objects (2) from possibly coming into contact with the rear wall (10′) of the box, where one or more air outlets (22′) are advantageously arranged, while allowing air to pass. This avoids clogging of these rear air outlets (22′) which open directly or otherwise to the external environment, the ejected objects not being able to reach said rear wall or bottom wall of the box.

In accordance with a preferred embodiment of the invention, and as shown in FIGS. 2 to 6, the sorter (3) of the facility is a binary type sorter (3), for example a binary optical sorter, and the outlet box (10) of the facility (1) comprises a single separating wall (8) dividing between them a first compartment (11) for receiving the non-ejected objects (2) and a second compartment (11′) for receiving the ejected objects (2).

Preferably, the separating wall (8) comprises, at and along its upper edge (8′), advantageously provided with a motorized roller (8″) forming a separator and located, where appropriate, above the plane of the conveyor (5), a wing (18) forming a flap inclined toward the first compartment (11) and arranged to divert over said upper edge (8′) the portion of the laminar air flow (FAL) leaving the guide tunnel (9′) and not diverted toward the discharge outlet (12) of the first compartment (11).

As shown in FIGS. 2 and 3, in particular by comparison with FIG. 1, the portion of the air flow leaving the tunnel (9′) which is not directed toward the first discharge outlet (12) is first diverted upward by the flap (18) and, after having passed the upper edge (8′), is directed into the compartment (11′) in relative depression, along the wall (8). This air trajectory ensures a better targeted ejection of the light objects and thus their delivery to the compartment (11′) and the appropriate discharge outlet. Specifically, they are less likely to fly and fall randomly on one side or the other of the separating wall (8).

In accordance with another advantageous feature of the invention, emerging from FIG. 4, which is compatible with the aforementioned features and variants and beneficial in relation to the maintenance at the outlet box (10), the upper deflecting wall (15) constitutes the upper closure wall or roof of the outlet box (10) and is mounted so as to be movable, by translation or pivoting, between a lowered working position and a raised maintenance position (cf. the arrow showing the pivoting movement of this wall at its front end and the arrow showing the upward movement at the rear).

In addition, the volume of the outlet box (10) advantageously has, in the raised position of the deflecting wall (15), a clear space sufficient to allow access by an operator, preferably in a standing position, into the compartment (11′) for receiving the ejected objects (2), for example through a door (19) mounted in a lateral wall of said box (10).

In addition, and as also shown in FIG. 4, at least one of the compartments (11, 11′), among the compartment (11) for receiving the non-ejected objects (2) and the compartment (11′) for receiving the ejected objects (2), is preferably equipped with a respective platform (20, 20′) for an operator, this or these platforms (20, 20′) being movably mounted between a retracted non-use position and a deployed use position, the movement from one position to the other being effected by sliding or tilting.

As illustrated in FIG. 4, a first platform (20) can be mounted so as to be able to move in translation between a stowed position below the conveyor (5) and a deployed position in the compartment (11) for receiving the non-ejected objects. A second platform (20′) can for its part be pivotably mounted on the rear wall (10′) of the outlet box (10) and thus be moved between a raised stowed position (against said wall) and a lowered position in which it extends into the compartment (11′) for receiving the ejected objects (see the arrows in FIG. 5).

In order to change the configuration of the facility (between work and maintenance) in a secure manner, the latter may comprise, according to a first variant embodiment, a controlled actuator, for example a hydraulic or electric cylinder, ensuring the controlled movement of the upper deflecting wall (15) between its lowered working position and its raised maintenance position. This actuator (not shown) can also ensure a simultaneous and synchronous movement at least of the platform (20′) associated with the compartment (11′) for receiving the ejected objects (2), between its retracted position and its deployed position (cf. the arrows indicating the translational and rotational movements in FIG. 4). In a variant, another actuator, optionally separately controlled, can move this platform (20′).

In accordance with another variant embodiment, only the second platform (20′) retractable by pivoting, and possibly the first platform retractable by translation, are moved by cylinders, the movement of the upper deflecting wall (15) between its lowered working position and its raised maintenance position being achieved by manual actuation (for example with a crank mechanism).

By virtue of the aforementioned technical provisions, in particular the use of the means influencing the aeraulic conditions in the box, tests carried out by the inventors with a binary sorting facility (1) and with a flow of objects (2) to be sorted comprising plastic films (not ejected, negative outlet or simple fall outlet) and sheets of office paper (ejected, positive outlet or second outlet) have made it possible to indicate, compared to similar tests with a facility according to FIG. 1:
At 3 m/s: reduction by 35% of the entrainment of the plastic films during the ejection of the paper (the purity of the ejected flow thus passed from 80 to 87%) and increase in the sorting efficiency (percentage of blown objects reaching the ejected outlet), which passed from 92% to 96% (this corresponds to a 50% reduction in sorting losses);
At 4.5 m/s: increased purity of the ejected paper flow from 87 to 95%, resulting in a 62% reduction in plastic film entrainment, and increase in sorting efficiency which passes from 92% to 96%, resulting in a 50% reduction in sorting losses.

By way of complementary means, in particular with respect to the diverting wing (14), which may prove beneficial in certain specific application cases in terms of controlling the aeraulic conditions and the air flows in the box (10), and as shown in FIGS. 5 and 6, it may be provided that the outlet box (10) is also subjected, in addition to the injection of air creating the laminar air flow (FAL), to air suction for discharging the excess air in the facility (1) to the outside, substantially without disturbing the flows of the objects (2) that are to be sorted or have been sorted.

To this end, the facility (1) may comprise two mutually independent air circulation devices (21, 22), for example with turbines, one (21) of which ensures the injection of external air for the generation of the laminar air flow (FAL) and the other (22) of which ensures the suction and discharge to the outside of the facility (1) of the excess air at the outlet box (10), the aforementioned air suction and discharge device (22) being adjusted or controlled in accordance with at least the surface area and quantity of the sorted objects (2) and with the possibilities of air passage to the outside at the discharge outlets (12).

Thus, the invention proposes, in relation to this possible variant, to achieve positive and controlled suction of the excess air, this being done independently of the injected air and taking into account the current situation in terms of spontaneous air discharge (in particular through the discharge outlets) and of the type and quantity of objects to be sorted. By virtue of this additional provision, it is thus possible in particular to further still increase the sorting performance (by improving the circulation of air at the outlet box), while limiting the energy consumption (by adapting the suction to the actual needs, which are limited because of the beneficial action of the diverting wing).

In the case of satisfactory discharge of excess air through the opening(s) (13 and/or 22′) for discharging air at atmospheric pressure, in particular present at the discharge outlets (12) and/or the rear wall (10′) or bottom wall of the box (10), and in particular when the diverting wing (14) fully fulfills its role of guiding the air flow (FAL) toward the first discharge outlet (12), the role of the suction device (22) and therefore its action may be greatly limited, as well as its energy consumption, or even suspended completely (stopping of the suction device).

Although the suction device (22) is essentially described and shown herein in relation to an active air circulation means (turbine or the like), it may in a variant be envisioned, as already mentioned above, that the suction of air toward the outside, in particular through one or more openings (22′) in the bottom or rear wall (10′), in addition to the opening(s) (13) in the lower part of the box or at the discharge outlets (12), is carried out passively, for example by venting via a discharge structure generating a natural suction phenomenon, or by simple pressure difference.

In addition, the outlet box (10) may optionally also comprise one or more air outlet openings (22′) fluidically connected to the air suction and discharge device (22) and located behind the upper deflecting wall (15) and/or behind the strip curtain (16). The wall (15) is then preferably perforated or apertured at its end proximal to the rear wall (10′) of the box (10) and adjoining the curtain (16).

At least one opening (22′) is preferably present in the rear wall (10′) of said outlet box (10), substantially facing and opposite the outlet (5″) of the conveyor (5), connected to a suction device (22) or directly to the external atmosphere.

In addition, by moving them away from the bottom of the box (10), the strips are less likely to be sucked in in the vicinity of the opening (22′) in the rear wall of the box (10) when suction is performed at least partially at this level.

In the first case, the strips (16) are sufficiently long to constitute a barrier between the suction opening (22′) of the rear or upper wall of the box to prevent ejected light objects from being sucked in at this level. Moreover, their distance from said rear wall (10′) must be such that the suction generated tends to cause most of the air present in the box (10) to bypass the strips (16) from below (cf. solid arrows on dashed line in FIG. 6). An air current and low pressure conditions are thus created in the compartment (11′), especially when the strips are tightened together and are located at an adequate distance from the rear wall, driving the ejected objects (2) downward and toward the corresponding discharge outlet (12). In practice, these strips (16) are located sufficiently far from this wall so that the speed of the air rising toward the suction opening is low and does not allow the entrainment of light objects, but also close enough to it so as not to reduce too much the free cross section of the compartment for ejected objects.

The strips (16), which are secured at their lower ends to the rear wall (10′) of the outlet box (10) or of the compartment (11′) receiving the ejected objects (2), are spaced apart from one another and constitute a curtain apertured by slot-shaped passages, and this apertured curtain is arranged transversely in the outlet box (10) so as to be traversed by the internal air sucked in by the device (22) ensuring the suction and discharge of said excess air.

Since the strip curtain (16) is apertured to allow air to pass through and is fixed in the lower part, it forms a puffy curtain overhanging in the compartment (11′). The objects (2) coming into contact with it are therefore unable to cling to it and fall by gravity into the appropriate discharge outlet (FIG. 5).

In accordance with an alternative construction to the strip curtain (16), the facility (1) may comprise, in the outlet box (10), an apertured flap (16) extending along and, at least in the upper part, at a distance from a rear wall (10′) of the outlet box (10) or of the compartment (11′) receiving the ejected objects (2), opposite the corresponding separating wall (8), so as to be located above and partially in the corresponding compartment (11′) for receiving the ejected objects (2), and thus to interfere with the trajectory of the ejected objects (2) capable of reaching said rear wall (10′), the cumulative cross sections of the openings or cutouts of the flap (16) being sufficient for the passage of the air to be discharged, freely or by suction, through the rear air outlet(s) (22′). The various provisions mentioned above in relation to the strip curtain also apply to this flap. The flap (16) is advantageously made of a flexible and relatively solid material (rubber, plastic). The openings of the latter may be arranged in a regular or non-regular pattern and may have various shapes (round, square, rectangular, triangular, etc.).

It will be noted that, in the two embodiments and variant embodiments shown in FIGS. 5 and 6, the air is sucked in above the compartment (11′) receiving the ejected objects (2), and preferably outside the trajectories of the latter.

Herein, the invention is shown in the appended figures and essentially described in relation to a binary sorting facility, that is to say with an outlet for the ejected objects (subjected to the action of an air jet) and an outlet for the non-ejected objects (not subjected to the action of an air jet and falling freely when leaving the conveyor). However, a person skilled in the art can easily transpose the improvements of the invention with his general knowledge to a ternary sorting facility, that is to say with two ejected outlets by adapting the air jet ejection device (7) (use of two different types of jets) and the outlet box (10) (presence of two separating walls 8 and three receiving compartments 11, 11′ and 11″, namely an additional receiving compartment for ejected objects, located between the two receiving compartments described and shown in FIGS. 2 to 6 and 8, or before or after them).

Thus, and as shown by way of examples in FIG. 9, such a ternary sorting facility (1) can more precisely comprise a ternary type sorter (3) with two separating walls (8) delimiting between them first, second and third compartments (11, 11′, 11″) for receiving non-ejected, weakly ejected or strongly ejected objects (2). Each separating wall (8) may comprise, at and along its upper edge (8′) forming a separator, advantageously a motorized roller (8″) and possibly a wing (18) forming a flap inclined toward the compartment (11 or 11′) which precedes it in the direction of the laminar air flow (FAL) and arranged to divert, over the upper edge (8′) of the separating wall (8) concerned, the portion of said laminar air flow (FAL) leaving the guide tunnel (9′) and not diverted toward the discharge outlet (12) of the compartment (11, 11′) which precedes it.

For the realization of ternary sorting, the facility (1) may also comprise i) a bar (7) with at least two types of nozzles alternating and oriented by type in different specific directions (not shown) or ii) at least two parallel bars (7 and 7′) with each of its nozzles oriented in a suitable manner (FIGS. 9A and 9B). In the latter case, the two bars (7 and 7′) are located at the outlet end (5″) of the conveyor (5), either both below the conveying plane of the belt (5′), as illustrated in FIG. 9A, or one (7) below the conveying plane of the belt (5′) and the other (7′) facing the first and above the conveying plane, substantially at the height of the diverting wing (14), as illustrated in FIG. 9B.

In FIGS. 9A and 9B, as in FIGS. 2, 3, 5, 6 and 8, the flow of the non-ejected objects (2), which normally constitutes the majority flow at the sorter outlet, is represented by a double arrow (double dashed line). Whereas in the binary sorting facility of FIGS. 2, 3, 5, 6 and 8, the compartment of the non-ejected objects is always the first compartment (11) following the outlet end (5″) of the conveyor (5), it may for example be either the first (11) or the second (11′) of the three consecutive compartments (11, 11′, 11″) in the case of a ternary sorting facility, as shown in FIGS. 9A and 9B, according to the arrangement of the bars (7, 7′) and their specific blowing direction.

As can be seen at least partially from FIGS. 9A and 9B, most of the features described above in relation to a facility (1) comprising a binary sorter in accordance with the invention and shown in FIGS. 2 to 6 and 8 can also apply to a facility (1) with a ternary sorter, in particular as regards the diverting wing (14), the deflecting wall (15), the strip curtain or the flap (16), the wing (18) and the means for injecting, channeling and sucking in/discharging air.

Of course, the invention is not limited to the embodiments described and shown in the appended drawings. Modifications remain possible, in particular as regards the makeup of the various elements or by substitution of equivalent techniques, without thereby departing from the scope of protection of the invention.

1. A facility for sorting objects comprising, mounted in a casing, a sorter with planar geometry and an aeraulic management system controlling the circulation of air in the facility, the sorter comprising at least:
a conveyor with a moving belt on which the objects to be sorted are arranged in a single layer or monolayer,
a detection device configured to inspect the objects circulating on the conveyor and classify them after analysis into at least two categories,
an air jet ejection device located at the outlet end of the conveyor and configured to selectively eject upward the objects detected as belonging to at least one of the classification categories and falling from said outlet end,
at least one separating wall arranged at a distance from the outlet end of the conveyor and configured to separate from one another a flow (FOCL) of freely falling objects and at least one flow of ejected objects, and
the aeraulic management system comprising at least:
a containment structure extending above the conveyor over a longitudinal part of the latter and forming therewith a guide tunnel into which is injected, by means of an external air injection device, a laminar air flow circulating substantially at the same speed as the objects to be sorted,
an outlet box, forming part of or mounted in the casing as appropriate, cooperating with the separating wall(s) to constitute a compartment for receiving the non-ejected objects and at least one compartment for receiving the ejected objects, these compartments having respective discharge outlets for discharging downward the categorized objects which have fallen or been projected therein,
which facility comprises at least one diverting wing arranged and configured to direct at least part, of the laminar air flow leaving the guide tunnel toward the discharge outlet associated with the compartment for receiving the non-ejected objects.

2. The facility for sorting objects as claimed in claim 1, wherein the diverting wing is located after the outlet of the tunnel for guiding the laminar air flow in the extension of and at a distance from the upper wall of the containment structure in the direction of the laminar air flow, and extends transversely to this direction, so as to be impacted by an upper fraction of said flow, after it has been ejected from said tunnel.

3. The facility for sorting objects as claimed in claim 1, wherein the diverting wing is mounted substantially at the inlet of the outlet box and has a configuration, a dimensioning and an arrangement such that the upper fraction of the laminar air flow which impacts it represents between about 15% and 35% by volume of said air flow ejected from the tunnel, and that the portion of said air flow diverted toward the discharge outlet associated with the compartment for receiving the non-ejected objects, or first discharge outlet, flows substantially along the separating wall.

4. The facility for sorting objects as claimed in claim 1, wherein the diverting wing is mounted with the possibility of being retracted upward, under the action of an object moving and coming into contact therewith as it passes below said wing.

5. The facility for sorting objects as claimed in claim 4, wherein the diverting wing is mounted so as to be pivotable about an axis arranged in a plane parallel to the plane of the conveyor and arranged perpendicularly to the direction of movement of the objects, said axis being located at a distance from the plane of the conveyor at least equal to the height of the tunnel and extending along one of the longitudinal edges of the diverting wing.

6. The facility for sorting objects as claimed in claim 1, wherein the facility comprises an upper deflecting wall of concave curved shape, mounted in the outlet box and extending above the openings of the compartments, substantially from the outlet end of the conveyor and following the containment structure, to a rear wall of the outlet box or of the compartment receiving the ejected objects, an inspection window for the detection device being arranged between the outlet of said containment structure, on the one hand, and said upper deflecting wall and said diverting wing, on the other hand.

7. The facility for sorting objects as claimed in claim 6, wherein the diverting wing is arranged between the outlet end of the conveyor and a front edge of the upper deflecting wall , at a distance from the outlet of the guide tunnel.

8. The facility for sorting objects as claimed in claim 1, wherein the facility comprises, in the outlet box, a strip curtain extending along and, at least in the upper part, at a distance from a rear wall of the outlet box or the compartment receiving the ejected objects, opposite the corresponding separating wall, so as to be located above and partially in the corresponding compartment for receiving the ejected objects, and thus to interfere with the trajectory of the majority of the ejected objects, the strips being either freely hanging or secured at their lower ends to the rear wall of the outlet box or of the compartment receiving the ejected objects.

9. The facility for sorting objects as claimed in claim 8, wherein the strips, secured or not at their lower ends to the rear wall of the outlet box or of the compartment receiving the ejected objects and, as appropriate, fastened in the upper part to the deflecting wall, are spaced apart from one another and constitute a curtain apertured by passages in the form of slots.

10. The facility for sorting objects as claimed in claim 1, wherein said facility comprises, in the outlet box, an apertured flap extending along and, at least in the upper part, at a distance from a rear wall of the outlet box or of the compartment receiving the ejected objects, opposite the corresponding separating wall, so as to be located above and partially in the corresponding compartment for receiving the ejected objects, and thus to interfere with the trajectory of the ejected objects capable of reaching said rear wall, the cumulative cross sections of the openings or cutouts of the flap being sufficient for the passage of the air to be discharged, freely or by suction, through the rear air outlet(s).

11. The facility for sorting objects as claimed in claim 1, wherein said facility comprises a binary type sorter and a single separating wall dividing between them a first compartment for receiving the non-ejected objects and a second compartment for receiving the ejected objects, this separating wall comprising, at and along its upper edge, advantageously provided with a motorized roller forming a separator and located as appropriate above the plane of the conveyor, a wing forming a flap inclined toward the first compartment and arranged to divert over said upper edge the portion of the laminar air flow leaving the guide tunnel and not diverted toward the discharge outlet of the first compartment.

12. The facility for sorting objects as claimed in claim 1, wherein said facility comprises a ternary type sorter with two separating walls delimiting first, second and third compartments for receiving the non-ejected, weakly ejected or strongly ejected objects, each separating wall being able to comprise, at and along its upper edge forming a separator, a motorized roller and a wing forming a flap inclined toward the compartment which precedes it in the direction of the laminar air flow and arranged to divert, over the upper edge of the separating wall concerned, the portion of said laminar air flow leaving the guide tunnel and not diverted toward the discharge outlet of the compartment which precedes it.

13. The facility for sorting objects as claimed in claim 12, wherein said air jet ejection device is a bar with at least two types of nozzles alternating and oriented by type in different specific directions.

14. The facility for sorting objects as claimed in claim 12, wherein the facility comprises at least two parallel bars with each of the nozzles oriented in a suitable manner, these two bars being located at the outlet end of the conveyor, either both below the conveying plane of the belt, or one below the conveying plane of the belt and the other facing the first and above the conveying plane, substantially at the height of the diverting wing.

15. The facility for sorting objects as claimed in claim 9, wherein the upper deflecting wall constitutes the upper closure wall or roof of the outlet box and is mounted so as to be movable, by translation or pivoting, between a lowered working position and a raised maintenance position, the volume of the outlet box having, in the raised position of the deflecting wall, a clear space sufficient to allow access by an operator, preferably in a standing position, into the compartment for receiving the ejected objects, for example through a door mounted in a lateral wall of said box.

16. The facility for sorting objects as claimed in claim 1, wherein at least one of the compartments among the compartment for receiving the non-ejected objects and the compartment for receiving the ejected objects, is equipped with a respective platform for an operator, this or these platforms being movably mounted between a retracted non-use position and a deployed use position, the movement from one position to the other being effected by sliding or tilting.

17. The facility for sorting objects as claimed in claim 1, wherein the outlet box is also subjected, in addition to the injection of air creating the laminar air flow, to air suction for discharging excess air in the facility to the outside, substantially without disturbing the flows of the objects that are to be sorted or have been sorted, and in that it comprises two mutually independent air circulation devices one of which ensures the injection of external air for the generation of the laminar air flow and the other of which ensures the suction and discharge to the outside of the facility of the excess air at the outlet box, the aforementioned air suction and discharge device being adjusted or controlled in accordance with at least the surface area and quantity of the sorted objects and with the possibilities of air passage to the outside at the discharge outlets.
